(19) United States
(12) Patent Application Publication
(10) Pub. No.: US 2023/0070628 A1
(43) Pub. Date: Mar. 9, 2023

(54) ELECTRIC MOTOR WITH MAGNETIC SHIELD INTEGRATED INTO END SHIELD

(71) Applicant: Nidec Corporation, Kyoto (JP)

(72) Inventor: Stanislaw ZBYROWSKI, Zegocina (PL)

(21) Appl. No.: 17/939,523

(22) Filed: Sep. 7, 2022

(30) Foreign Application Priority Data
Sep. 7, 2021 (DE) 10 2021 123 150.7

(51) Int. Cl. H02K 11/01; B22D 19/00; B22D 21/00; H02K 3/42; H02K 5/15; H02K 5/22

(52) U.S. Cl. CPC H02K 11/012; B22D 19/0054; B22D 21/007; H02K 3/42; H02K 5/15; H02K 5/225

(57) ABSTRACT

An electric motor includes a rotor mounted rotatably about an axis of rotation in a bearing accommodated in an end shield, and a stator including wound coils such that windings are defined by at least one winding wire with winding wire ends electrically connected to busbars of a busbar unit. The busbar unit is on an upper side of the stator and the end shield is seated on an upper side of the busbar unit. A magnetic shield is integrated into the end shield.

### CROSS REFERENCE TO RELATED APPLICATION

The present application claims priority under 35 U.S.C. § 119 to German Application No. 102021123150.7 filed on Sep. 7, 2021, the entire contents of which are hereby incorporated herein by reference.

### FIELD OF THE INVENTION

The present disclosure relates to an electric motor.

### BACKGROUND

Brushless electric motors, which can be controlled particularly well and efficiently, are frequently used in motor vehicle steering systems. The DC motors include a rotor connected to a motor shaft and rotatably mounted in a housing. The rotor is equipped with permanent magnets. Associated with the rotor is a stator, which carries a number of windings on an iron core. When suitably controlled, the windings generate a magnetic field which drives the rotor to rotate. Strong radiation of electromagnetic waves by the electric motor in the direction of the control unit is often unacceptable or undesirable. Therefore, such electric motors must be carefully shielded and/or their interferences suppressed.

Conventionally, a separate shield plate is arranged between the stator and an end shield for shielding, which has two pins for fastening that are clipped into the end shield.

### SUMMARY

Example embodiments of the present disclosure provide brushless electric motors each including a magnetic shield that is particularly simple and inexpensive.

An electric motor according to an example embodiment of the present disclosure includes a rotor mounted rotatably about an axis of rotation in a bearing which is accommodated in an end shield. The rotor is surrounded externally by a stator including wound coils, the windings being provided by at least one winding wire with winding wire ends electrically contacted with busbars of a busbar unit. The busbar unit is on an upper side of the stator and the end shield is seated on an upper side of the busbar unit. For magnetic shielding of the electric motor, a magnetic shield is integrated into the end shield. This eliminates the need for additional time-consuming attachment of the magnetic shield to the end shield, and the magnetic shield can be of particularly simple design, thus saving material.

Preferably, the magnetic shield includes a shield plate, wherein a material, preferably aluminum, is injection molded around the shield to form the end shield. Preferably, the magnetic shield is made of steel.

It is advantageous if the end shield with the integrated magnetic shield extends in the axial direction between the busbar unit and a printed circuit board in order to shield a controller on the printed circuit board from interfering magnetic fields.

Preferably, the shield includes a tubular section that surrounds the bearing circumferentially. It is advantageous if the shield includes an annular rim adjoining the tubular section, which extends in the axial direction between the printed circuit board and the busbar unit. The annular rim is thus oriented parallel or substantially parallel to the upper side of the stator.

Another example embodiment of the present disclosure provides a method of manufacturing a brushless electric motor described above including providing a die casting tool to manufacture an end shield, inserting a magnetic shield into the die casting tool, injecting aluminum into the die casting tool to form the end shield, mounting the end shield on top of a stator, and electrically connecting a printed circuit board with a busbar unit such that the printed circuit board is on the end shield.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal section view through a brushless electric motor with magnetic shielding.

### DETAILED DESCRIPTION

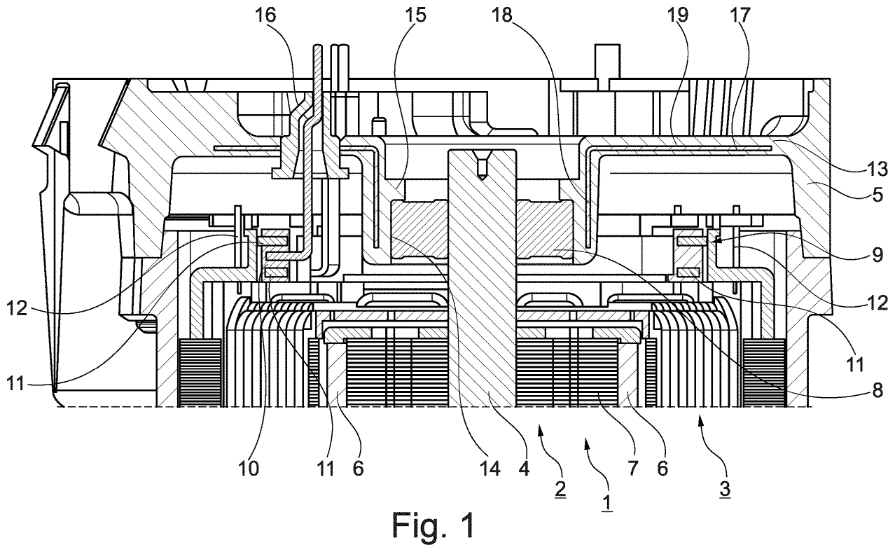

FIG. 1 shows an electric motor 1 with rotor 2 and stator 3. The stator 3 surrounds the rotor 2 circumferentially. The rotor 2 is connected to a rotor shaft 4 and is rotatably mounted in a housing 5. The rotor 2 carries permanent magnets 6. The permanent magnets 6 are arranged around a rotor core 7 and are seated on the outside thereof.

Two bearing systems are usually provided for fixing the rotor 2. Often these bearings are designed as ball bearings, with the electromagnetic assemblies located between the bearings. FIG. 1 shows one of the bearings 8. The bearing 8 lies in the axial direction on the side remote from the stator (above) a busbar unit 9. The busbar unit 9 conventionally includes a busbar holder 10 and busbars 11 arranged in the busbar holder 10. The busbars 11 are made of an electrically conductive material, preferably metal, in particular copper. The busbar holder 10 includes at least partially or completely of an electrically insulating material, so that short circuits between the busbars can be effectively prevented. The busbar holder 10 is in contact with the stator 3 (upper side) on one axial side thereof and is connected thereto. The winding wire ends 12 of the windings arranged in the stator 3 are electrically connected to the busbars 11 in a known manner. The busbar unit 9 is set up to make electrical contact with the coils of the stator by means of the busbars 11.

The bearing 8 is seated in an end shield 13. The end shield 13 includes a central opening 14 and an annular shoulder 15 located in the opening to receive the bearing 8. The opening 14 is penetrated by the rotor shaft 4. The end shield 13 is formed integrally with the housing 5. The bearing 8 lies with one side in contact with the shoulder 15 of the end shield 13. The end shield 13 is arranged on the side remote from the stator above the busbar unit 9 and is penetrated by power source connection elements 16 of the busbars. The end shield 13 does not touch the busbar unit 9. The power source connection elements 16 provide an electrical contact to a control unit (not shown) to control the electric motor 1. The power source connection elements 16 penetrate the end shield 13. A magnetic shield 17 is integrated into the end shield 13. The magnetic shield 17 preferably includes a metal plate, for example, a steel plate, which is overmolded during the manufacture of the end shield 13. The end shield 13 is preferably formed from aluminum or plastic. To manufacture the end shield 13, aluminum preferably is injected into a die casting tool. During manufacture, the magnetic shield 17 is located in the die casting tool and is overmolded by the aluminum.

The shield 17 is a tubular sheet, with an annular rim 19 at a first end of the tubular section 18. The tubular section 18 preferably has a circular cross-section. The opening of the second end of the tubular section opposite to the first end, when installed, is penetrated by the rotor shaft 4 and coaxially surrounds it. The tubular section 18 thus fully surrounds the bearing 8 on the outside. The tubular section 18 is located in a radial direction to the axis of rotation of the rotor shaft between bearing 8 and a connecting area between the busbars 11 and the winding wire ends 12. The annular rim 19 of the shielding 17 is located above the busbar unit 9 (parallel to it) and completely covers it. The shielding 17 is penetrated by the power source connections of the busbar unit 16. The annular rim 19 lies in the axial direction between the busbar unit 9 and a printed circuit board (not shown) on which the control unit is located.

The magnetic shield has a particularly simple design and can therefore be manufactured cost-effectively. By overmolding the shield during manufacture of the end shield, an otherwise necessary fastening step during assembly is eliminated. Since no fastening of the shield to the housing is necessary, a holding force check can also be dispensed with.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric motor comprising:
an end shield;
a bearing in the end shield;
a rotor mounted rotatably about an axis of rotation in the bearing; and
a stator including coils wound such that windings are provided by at least one winding wire with winding wire ends electrically connected to busbars of a busbar unit located on a top side of the stator and the end shield being seated on a top side of the busbar unit; wherein
a magnetic shield is integrated into the end shield.

2. The electric motor according to claim 1, wherein the magnetic shield includes a shield plate and the end shield is defined by an injection molded material around the shield plate.

3. The electric motor according to claim 2, the injection molded material is aluminum.

4. The electric motor according to claim 1, wherein the end shield with the magnetic shield extends in an axial direction between the busbar unit and a printed circuit board carrying a controller.

5. The electric motor according to claim 2, wherein the shield includes a tubular portion fully circumferentially surrounding the bearing.

6. The electric motor according to claim 5, wherein the shield includes an annular rim adjoining the tubular portion and extending in the axial direction between the printed circuit board and the busbar unit.

7. A method of manufacturing an electric motor including a rotor mounted rotatably about an axis of rotation in a bearing accommodated in an end shield, and a stator including coils wound to provide windings defined by at least one winding wire with winding wire ends electrically connected to busbars of a busbar unit located on an upper side of the stator, the method comprising:
providing a die casting tool to produce the end shield;
inserting a magnetic shield into the die casting tool;
injecting aluminum into the die casting tool to form the end shield;
mounting the end shield on top of the stator; and
electrically connecting a printed circuit board with the busbar unit; wherein
the printed circuit board is on the end shield.
